(19) United States
(12) Patent Application Publication
(10) Pub. No.: US 2019/0025337 A1
(43) Pub. Date: Jan. 24, 2019

(54) ROTATION DETECTION APPARATUS

(71) Applicant: DENSO CORPORATION, Kariya-City (JP)

(72) Inventors: Hiroyuki TSUGE, Kariya-city (JP); Yasuhiro HARADA, Kariya-city (JP)

(21) Appl. No.: 16/036,040

(22) Filed: Jul. 16, 2018

(30) Foreign Application Priority Data
Jul. 18, 2017 (JP) 2017-139205

(51) Int. Cl. G01P 3/44; H02K 11/215; F16C 41/00; F16C 35/04

(52) U.S. Cl. CPC G01P 3/443; H02K 11/215; B60B 27/0068; F16C 35/042; F16C 2326/02; F16C 41/007

(57) ABSTRACT

A rotation detection apparatus includes a plurality of detection elements each outputting a signal responding to a change in magnetic flux caused by a rotation of a rotor, and a sensor body including the plurality of detection elements. The plurality of detection elements output signals having mutually different phases with respect to peaks of waveforms corresponding to respective output signals.

### CROSS-REFERENCE TO RELATED APPLICATION

This application is based on and claims the benefit of priority from earlier Japanese Patent Application No. 2017-139205 filed Jul. 18, 2017, the description of which is incorporated herein by reference.

### BACKGROUND

### Technical Field

The present disclosure relates to a rotation detection apparatus that detects rotation of an object to be detected based on rotation of a rotor.

### Description of the Related Art

Conventionally, as such a rotation detection apparatus, for example, Japanese Patent Application Laid-Open Publication No. 2005-30953 discloses an integrated structure of a sensor body and a hub unit, in which the sensor element is provided with a sensing element and a signal processing circuit or the like which processes an output signal from the sensing element. The rotation detection apparatus includes a circular multipolar magnet and a magnetizing rotor disposed facing the detection element and outputs a signal in accordance with a change in magnetism caused by the rotation of the magnetizing rotor. The rotation detection apparatus is used for a wheel speed sensor in vehicles such as cars.

Since the above-mentioned wheel speed sensor provided with a detection element outputs a signal in accordance with a rotation speed of the magnetizing rotor which rotates together with the wheels, when the vehicle is running with extremely low speed before stopping, for example, during parking, the amount of signal (i.e., the number of pulses) is small so that the resolution thereof is low.

In this respect, to improve the resolution in extremely low speed traveling, the number of poles of the multipolar magnet provided facing the detection element in the wheel speed sensor may be increased. Specifically, it is considered that the number of pulses of the detection element, that is, the number of pulses outputted by the detection element when the magnetizing rotor rotates once (hereinafter simply referred to as “the number of pulses of signal”) may be simply increased. This method is effective during extremely low speed travelling. However, unnecessary pulses increase during high-speed travelling.

Specifically, when simply increasing the number of pulses of the detection element, the following problems may arise, that is, a processing load of an external signal processing unit (e.g., ECU) which processes the output signal of the detection element during high speed travelling may become large so that processing speed of the signal processing may be slow so that required processing speed cannot be maintained.

### SUMMARY

The present disclosure has been achieved in light of the above-mentioned circumstances and provides a rotation detection apparatus provided with a plurality of detection elements, capable of increasing the resolution during extremely low-speed travelling and suppressing a processing load of the ECU during high-speed travelling.

A first aspect of the present disclosure provides a rotation detection apparatus including a plurality of detection elements each outputting a signal responding to a change in magnetic flux caused by a rotation of a rotor; and a sensor body including the plurality of detection elements.

In such a configuration, the plurality of detection elements output signals having mutually different phases with respect to peaks of waveforms corresponding to respective output signals.

Thus, since a plurality of detection elements are provided in the rotation detection apparatus, the output signals from the respective detection elements, responding to the rotation of the rotor rotating together with an external rotational body, are different in phases at the peak of each waveform thereof. Therefore, the configuration allows the output signals to produce a synthesized signal having a larger number of pulses. With the synthesized signal, the rotation detection apparatus enhances the detection resolution.

Thus, even when the rotor rotates at an extreme low speed, the plurality of detection elements output signals which can be synthesized by an external signal processing unit to produce a synthesized signal having a large number of pulses. Hence, the rotation detection apparatus according to the present disclosure improves the detection resolution. On the other hand, when the rotor rotates with high speed, only one detection element in the plurality of detection elements is used so that processing load of the external signal processing unit can be prevented from increasing.

Note that reference signs in parentheses in respective means refers to correspondence with specific means described in embodiments which will be described later.

### BRIEF DESCRIPTION OF THE DRAWINGS

In the accompanying drawings:

FIG. 1 is a cross-sectional view of a rotation detection apparatus according to a first embodiment of the present disclosure;

FIG. 2 is an enlarged cross-sectional view showing a sensor body of the rotation detection apparatus according to the first embodiment;

FIG. 3 is a plan view showing the sensor body viewed from an end face where the detection elements are arranged;

FIG. 4 is a diagram showing a relationship between a waveform of the output signal of the detection element and a multipolar magnet;

FIG. 5A is a block diagram showing a transmission path of an output signal of a detection element in a conventional rotation detection apparatus;

FIG. 5B is a block diagram showing a transmission path of an output signal of a detection element in a rotation detection apparatus according to the first embodiment;

FIG. 6 is a diagram showing output signals from two detection elements, a phase difference of the output signals between two detection elements, and a waveform of a synthesized signal in which the two output signals are synthesized;

FIG. 7 is a diagram showing an arrangement of two detection elements;

FIG. 8 is a diagram showing a structure of a sensor body according to another embodiment;

FIG. 9 is a diagram showing other transmission path of an output signal of a detection element; and

FIG. 10 is a diagram showing another waveform example of output signals of the detection elements.

### DETAILED DESCRIPTION OF PREFERRED EMBODIMENTS

Hereinafter, with reference to the drawings, embodiments of the present disclosure will be described. Note that the same reference numbers are applied to mutually identical or equivalent parts in the respective embodiments in the following description.

### First Embodiment

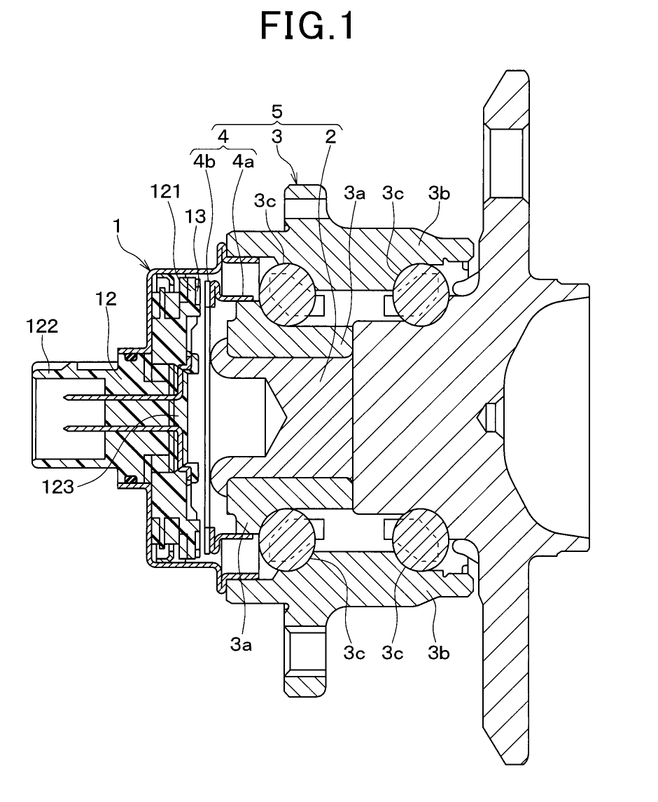

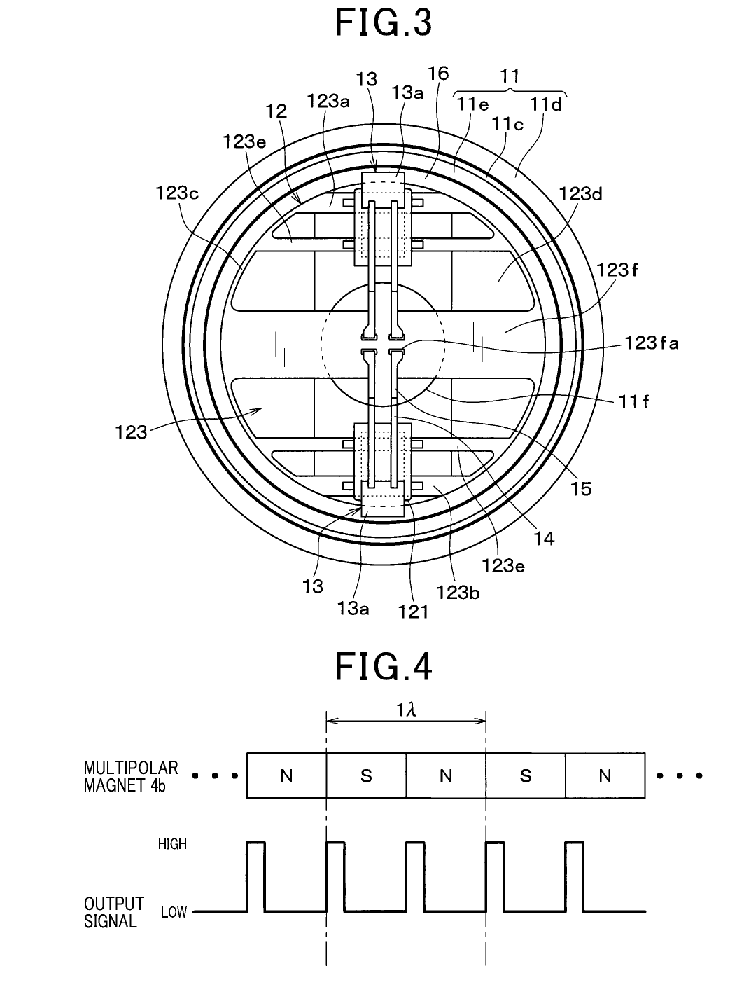

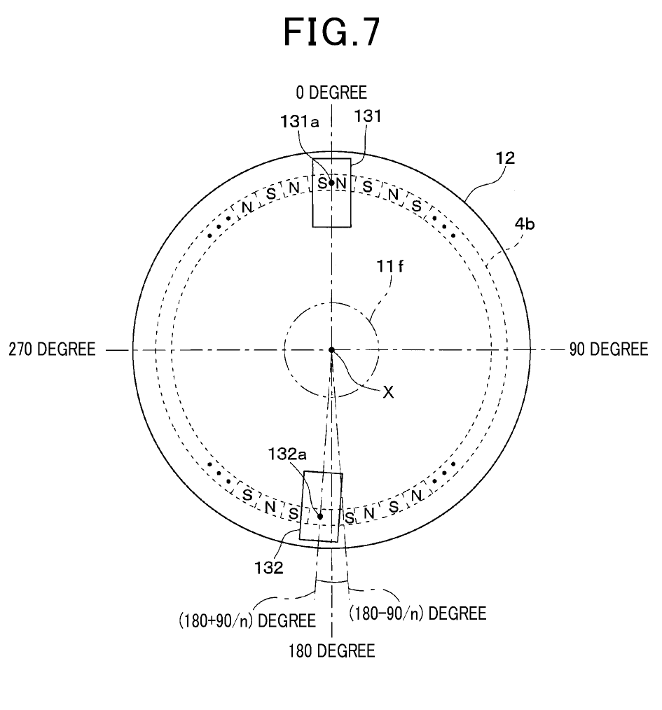

With reference to FIGS. 1 to 7, a rotation detection apparatus according to a first embodiment will be described as an example of a wheel speed sensor mounted on a vehicle such as a car. In FIG. 3, in order to easily understand the configuration, a part of a detection element 13 which is hidden because of a hold portion 121 of a resin formation portion 12 (described later), a part of a side wall portion 11f which is hidden because of a center portion 123f and a part of a metal ring 16 which is hidden because of the detection element 13 are indicated by dotted lines. In FIG. 7, in order to easily recognize an arrangement of the detection elements 131 and 132 which will be described later, a position facing the multipolar magnet 4b in the resin formation portion 12, that is, a circle of which the center is defined as rotation axis X when viewed from the hub shaft 2 side, is shown with a dotted line, and other part of the configurations are omitted. Also, in FIG. 7, the center line of the circle having the rotational axis X as the center thereof is shown with a chain line and an inner wall surface of the side wall portion 11f in the cover 11 is shown with a two-dot chain line.

As shown in FIG. 1, the rotation detection apparatus according to the present embodiment is provided with a sensor body 1 including a plurality of detection elements 13. The sensor body 1 is attached to a hub unit 5 provided with a hub shaft 2, a hub inner wheel 3a attached to the hub shaft 2 and a rotor 4 fixed to the hub inner wheel 3a. In this section, with reference to FIG. 1, first, the hub unit 5 to which the rotation detection apparatus according to the present embodiment is attached will be described.

As shown in FIG. 1, the hub shaft 2 has a shape in which a column member having two substantial column members of which the diameters are mutually different has a flange portion at the substantial column member having larger diameter than the other substantial column member. The hub shaft 2 is connected to a wheel (not shown) in an opposite end face side of the sensor body 1, and rotates together with the wheel.

As shown in FIG. 1, a hub unit bearing 3 is configured of a hub inner wheel 3a and a hub outer wheel 3b having different radiuses, and a rolling body 3c.

As shown in FIG. 1, the hub inner wheel 3a is a member having a substantial cylindrical shape in which the column member of the hub shaft 2 having a smaller diameter is inserted. An insertion part inserted into an inner side of the hub inner wheel 3a of the hub shaft 2 comes into contact with the inner periphery surface of the hub inner wheel 3a, and the tip end of the insertion part is caulked. Since the hub inner wheel 3a comes into contact with a part of the hub shaft 2 and supports the part thereof, the hub inner wheel 3a rotates together with the hub shaft 2.

As shown in FIG. 1, the hub outer wheel 3b is a member having a substantial cylindrical shape and surrounding an outer periphery surface of the hub inner wheel 3a via the rolling body 3c having a sphere shape. The hub outer wheel 3b is fixed to a vehicle side (not shown) serving as a member that maintains a stationary state even when the hub inner wheel 3a rotates.

The rolling body 3c is a member having a sphere shape, and disposed between the hub inner wheel 3a and the hub outer wheel 3b, allowing the hub inner wheel 3a and the hub outer wheel 3b to relatively rotate.

According to the present embodiment, the rotor 4 serves as a magnetizing rotor configured of a rotation part 4a having a substantial cylindrical shape and a circular multipolar magnet 4b fixed to the rotation part 4a.

As shown in FIG. 1, the rotation part 4a is press-fitted in the hub inner wheel 3a and comes into contact with an outer periphery surface of the hub inner wheel 3a. The rotation part 4a rotates together with the hub inner wheel 3a when the hub shaft 2 connected to the wheel rotates.

The multipolar magnet 4b is formed in a circular shape in which magnets such as gum magnets or plastic magnets are magnetized with N poles and S poles arranged alternately in a circumferential direction of which the center is defined as a rotational axis of the rotor 4. The multipolar magnet 4b is fixed to the rotation part 4a so that the multipolar magnet 4b rotates together with the rotation part 4a when the hub shaft 2 and the hub inner wheel 3a rotate.

In other words, the rotor 4 rotates in response to a rotation of the hub inner wheel 3a. When the rotor 4 rotates in a state where the rotor 4 is disposed facing the detection element 13 fixed to the rotor 4, the N-pole and the S-pole of the multipolar magnet alternately pass over the detection element 13. That is, the rotor 4 rotates together with the hub shaft 2 and the hub inner wheel 3a, thereby causing a change in magnetic flux at the detection element 13.

According to the present embodiment, the multipolar magnet 4b is configured such that respective dimensions with respect to the circumferential direction of the N-pole magnet and the S-pole magnet arranged in the circumferential direction are the same. For example, the multipolar magnet 4b has a configuration in which 48 N-pole magnets and 48 S-pole magnets are magnetized.

Next, each element of the rotation detection apparatus of the present embodiment will be described.

As shown in FIGS. 1 to 3, the sensor body 1 is composed of the cover 11, the resin formation portion 12, two detection elements 13, a plurality of lead portions 14, a plurality of terminals 15, a metal ring 16 and an O-ring 17.

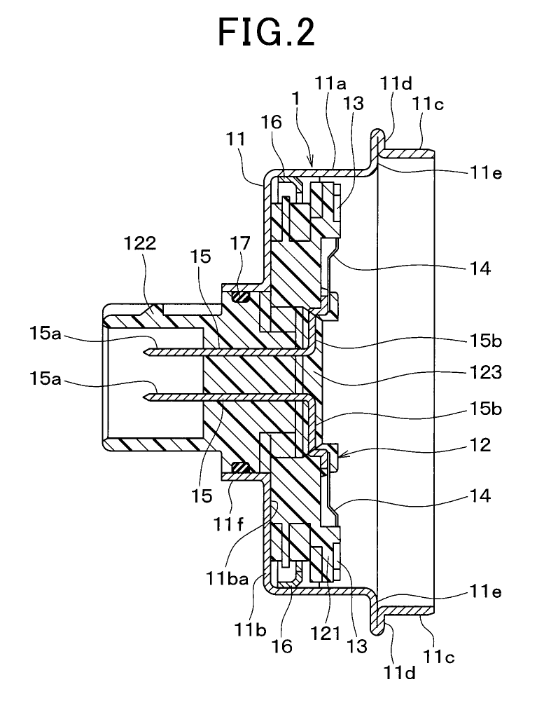

The cover 11 is made of metal, having a substantial cylindrical shape, for example. As shown in FIGS. 1 and 2, the cover 11 is configured of a side surface portion 11a having a cylindrical shape, a bottom surface portion 11b having a lid shape, a contact portion 11c contacted with the inner periphery surface of the hub outer wheel 3b, a flange shape portion 11d, 11e and the side wall portion 11f.

As shown in FIG. 2, the side wall portion 11a has a substantially cylindrical shape to which the hold portion 121 and a support portion 123 in resin formation portion 12 (described later) are inserted.

As shown in FIG. 2, the bottom surface portion 11b has an opening portion in the vicinity of the center of a mount surface 11ba when viewed from a normal direction with respect to the mount surface 11ba (hereinafter referred to as bottom surface normal direction), where the mount surface 11ba is defined as a surface facing a hub unit 5 side in the bottom surface portion 11b.

The contact portion 11c is located in an end portion of the hub shaft 2 side in which the diameter of the contact portion 11c is the same as or slightly larger than that of the inner periphery of the hub outer wheel 3b. For the contact portion 11c, as shown FIGS. 1 and 2, a part of the cover 11 that constitutes the sensor body 1 is press-fitted to the hub outer wheel 3b in the hub unit bearing 3, whereby the contact portion 11c contacts with the inner periphery surface of the hub outer wheel 3b.

As shown in FIGS. 1 and 2, the flange shape portion 11d is formed protruding towards outside from the inside the cover 11. For the flange shape portion 11d, as shown in FIG. 1, a part of the cover 11 is press-fitted to the hub outer wheel 3b, whereby the flange shape portion 11d contacts with the end face of the hub outer wheel 3b.

The flange shape portion 11e is located between the side surface portion 11a and the contact portion 11c inside the cover 11, facing the hub unit bearing 3.

As shown in FIG. 2, the side wall portion 11f is provided in an opposite surface of the mount surface 11a of the bottom surface portion 11b, the side wall portion 11f having an opening of which the inner diameter is the same as the opening of the bottom surface portion 11b. A connector portion 122 (described later) in the resin formation portion 12 is fitted inside the side wall portion 11f.

Thus, the contact portion 11c of the cover 11 contacts with the hub outer wheel 2b and press-fitted to the hub outer wheel 2b, whereby the sensor body 1 does not rotate together with the hub shaft 2.

The resin formation portion 12 is disposed inside the bottom surface portion 11b of the cover 11 to touch the inner surface of the bottom surface portion 11b. The resin formation portion 12 includes a plurality of hold portions 121 that hold the detection elements 13, the connector portion 122 for connecting the detection elements 13 to external electrodes, and the support portion 123. The resin formation portion is composed of resin material, for example, polybutylene terephthalate (PBT) or the like, and constituted of an integrated structure including the hold portion 121, the connector portion 122 and the support portion 123 which are injection-molded at one time.

The hold portion 121 is disposed to face the mount surface 11ba, serving as a portion that holds the detection element 13. The hold portion 121 is also disposed to face the hub shaft 2 when being attached to the hub unit 5. The support unit 121 is disposed at a position not to contact with the rotor 4, when the sensor body 1 is press-fitted to the hub unit 5. Thus, as shown in FIG. 1, the detection element 13 is disposed being apart from the rotor 4 via a slight gap therebetween.

The connector portion 122 is disposed in an opposite side of the mount surface 11ba with respect to the hold portion 121 in the resin formation portion 12. The connector portion 122 is formed in a substantially cylindrical shape. The connector portion 122 has a concave portion formed at a portion having the diameter similar to the inner diameter of the side wall portion 11f. As shown in FIG. 2, the connector portion 122 and the side wall portion 11f are sealed by the 0 ring 17 which is inserted into the concave portion.

The support portion 123 couples the hold portion 121 and the connector portion 122 to be integrated. The support portion 123 includes an upper portion 123a, a lower portion 123b and a beam portion 123e which are arranged such that extending directions are matched when viewed from the normal direction of the bottom surface, and an outer periphery portion 123c having a substantial arc-shaped which connects the upper portion 123a, the lower portion 123b and the beam portion 123e at both ends of respective portions. Also, the support portion 123 includes a plate portion 123d disposed inside the outer periphery portion 123c and a center portion 123f in which the both ends are connected to the outer periphery portion 123c and the extending direction is matched with the upper portion 123a and the like. A part of the outer periphery portion 123c is hidden by the metal ring 16. A surface parallel to the bottom surface portion 11b in the outer periphery portion 123c and the plate portion 123d appears substantially circular when viewed from the bottom surface normal direction.

According to the present embodiment, the resin formation portion 12 is disposed such that two hold portions 121 are disposed in an outer side than the center of the resin formation portion 12 when viewed from the bottom surface normal direction as shown in FIG. 3. Each of the hold portions 121 holds the detection element 13 and supported by the upper portion 123a and the beam portion 123e and supported by the lower portion 123b and the beam portion 123e.

The detection element 13 integrates an IC (integrated circuit) chip and magnet or the like by molding with resin. The IC chip includes a magneto resistive element (MRE) as a sensing element that outputs a signal responding to a change in magnetic flux. The detection element 13 may include a signal processing circuit that processes a signal outputted by the MRE element. Note that the sensing element may be, for example, a Hall element, a giant magnetresistive effect (GMR) element, a tunnel magneto resistance (TMR) element or the like, and is not limited to an MRE element but may be an element in which no magnets are included.

The detection element 13 includes a detection portion 13a that detects a change in magnetic flux as shown in FIG. 3. The detection element 13 is press-fitted to the hold portion 121 in a state where the detection portion 13a is exposed from the hold portion 121. The detection element 13 is provided in the senor body in the plural number. According to the present embodiment, two detection elements 13 are provided.

As shown in FIG. 1, according to the present embodiment, each of the detection elements 13 is arranged facing the rotor 4. Respective detection elements 13 outputs, as signals responding to the rotation of the rotor 4, signals having mutually different phases at the peak of the waveform of the output signals. The arrangement of the detection signal 13 and the phases of the signals will be described later in detail.

As shown in FIG. 3, the lead portions 14 are electrically connected to the detection elements 13.

As shown in FIG. 2, an end 15a of the terminal 15 is exposed to the connector portion 122. As shown in FIG. 3, the other end 15b of the terminal 15 is extended from an opening 123fa in the center portion 123f provided on the opening of the cover 11 when viewed from the bottom surface normal direction, and electrically connected to the lead portion 14 by a soldering, a caulking or a welding. Thus, the output signal outputted from the detection element 13 is transmitted through the lead portion 14, and then transmitted to an external signal processing unit such as ECU via the terminal 15.

The configurations of the rotation detection apparatus according to the present embodiment is described as above.

Next, with reference to FIGS. 4 to 6, an arrangement of the detection element 13 and effects obtained from this arrangement will be described.

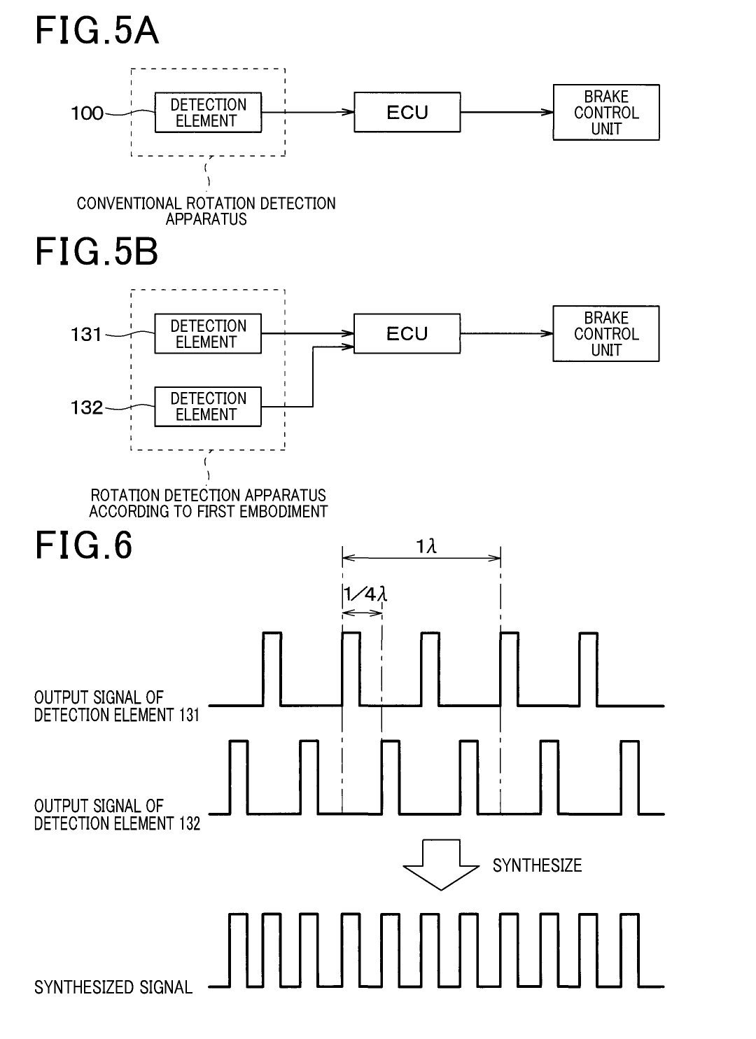

First, the output signal of the detection element 13 responding to a rotation of the rotor 4 will be described with reference to FIG. 4. FIG. 4 illustrates a relationship between waveform of the output signal of the detection element and positions of the N-polar magnet and the S-polar magnet in the multipolar magnet 4b. In FIGS. 5 and 6, for the sake of convenience, one of two detection elements 13 is defined as a first detection element 131 and the other one of the two detection elements 13 is defined as a second detection element 132.

When the rotor 4 rotates the detection elements 131 and 132 output a signal in response to a change in magnetic flux produced by alternately changing magnetic poles between N-pole and S-pole with rotation of the multipolar magnet 4b which is arranged apart from the detection elements 131 and 132 via a gap therebetween.

Specifically, as shown in FIG. 4, the first detection element 131 outputs signal when the magnet facing the first detection element 131 changes the pole from N-pole to S-pole, or S-pole to N-pole, that is, direction of the magnetic flux changes (hereinafter simply referred to as “when magnetic flux changes”). The first detection element 131 outputs, for example, a pulse signal shown in FIG. 4 where a high level signal is outputted when the magnetic flux changes and a low level signal is outputted while magnetic flux has not been changed, that is, a period different from that the magnetic flux changes.

In the above-described embodiment, the first detection element 131 is described. However, an output signal produced by a change in the magnetic flux and a waveform of the output signal are similar to those of the first detection element 131. In the above description, an example is described in which a pulse signal is used as an output signal. However, this is not limited thereto. For example, peak waves appearing as pulse-like waves or other waveforms can be used. Further, an amplitude of a high level part of the output signal corresponding to each of the detection element 131 and 132 and an interval between high level parts may preferably be the same considering the synthesizing of output signals which will be described later. For the sake of convenience, an example has been described where a pulse signal rises at a boundary portion between adjacent poles. Alternatively, for example, the pulse signal may rise at the center of the N-pole or the S-pole, and the pulse signal does not necessarily have to rise at the boundary portion between adjacent poles.

With reference to FIG. 5, signal processing in a conventional rotation detection apparatus and a rotation detection apparatus according to the present embodiment, and effects obtained from the rotation detection apparatus according to the present embodiment, will be described.

In the conventional apparatus, as shown in FIG. 5A, a detection element 100 outputs a signal to a single ECU, and the external ECU transmits a signal to a brake control unit after processing the signal outputted by the detection element 100.

Considering a case where a vehicle is travelling with high seed, for example, travelling at 30 km/h or more, a rotation frequency of the rotor 4 is high, that is, a change in the magnetic flux is large so that many high pulses are outputted. In this condition, since the number of high pulses outputted by the single detection element 13 is large, sufficient resolution can be secured even when using output signal from single detection element 13.

On the other hand, when the vehicle is travelling at a low speed, for example, travelling at 5 km/h or less, the rotation frequency of the rotor 4 is low, that is, an amount of change in the magnetic flux is small so that fewer high pulses are outputted compared to a case where the vehicle is travelling with high speed. In particular, when the vehicle is travelling at extremely low speed, for example, travelling at less than 1 km/h, the number of pulses outputted by the single detection element 13, that is, an amount of signal in a predetermined period is significantly small. In other words, almost no signal is present for calculating the vehicle speed, which causes low resolution. As a result, in extremely low speed travelling, it is difficult for a conventional rotation detection apparatus having a single detection element to detect the rotation, with such a low resolution.

To increase the resolution in extremely low speed travelling, the number of poles of multipolar magnet 4b may be increased to increase the number of pulses of signal outputted by the detection element 13. However, according to this method, the number of pulses of the detection element 13 during extremely low speed travelling can be increased but the number of pulses in high speed travelling becomes excessively large so that the processing load of the ECU will increase. As a result, the signal processing in the ECU may be delayed or the signal processing cannot meet the required speed of the signal processing.

In this regard, the inventors of the present disclosure have studied and invented a rotation detection apparatus provided with a plurality of detection elements 13. The rotation detection apparatus outputs signals having different phases at their peaks of waveform corresponding to respective detection elements 13 so as to increase the number of pulses by synthesizing a plurality of output signals as needed.

According to the rotation detection apparatus of the present embodiment, as shown in FIG. 5B, each of the two detection elements 131 and 132 outputs a signal to an external ECU. Then the ECU processes these signals and outputs the processed signals to a brake control unit or the like mounted on a vehicle. The detection elements 131 and 132 are arranged to output signals having mutually different phases at the peak of the waveform of the output signals so as to increase the number of pulses of a signal where the respective output signals are synthesized (hereinafter referred to “synthesized signal”). Thus, a rotation detection apparatus is configured to output a plurality of output signals having mutually different phases, thereby improving the resolution during extremely low speed travelling without increasing the number of pulses of the output signal for each detection element 13.

In high speed travelling, only one signal outputted by all of the plurality of detection elements 13 is used so that an increase in the processing load of the ECU caused by increasing pules of unnecessary output signal can be suppressed. An external ECU determines whether respective output signals of the plurality of detection elements 13 are synthesized, based on the rotation frequency of the rotor 4.

Subsequently, with reference to FIG. 6, phase difference between the first detection element 131 and the second detection element 132 will be described.

The detection elements 131 and 132 are arranged to produce a phase difference between the output signals of the detection elements 131 and 132 (output signals of two systems) to avoid overlapping between high level parts of respective output signals. Specifically, the detection elements 131 and 132 are arranged such that the relative positions thereof are shifted with respect to the multipolar magnet 4b. For example, when the detection portion 131a of the first detection element 131 is disposed on a boundary portion between adjacent N-pole and S-pole in the multipolar magnet 4b, the detection portion 132a of the second detection element 132 is disposed at a position different from the boundary portion between the N-pole and the S-pole.

Here, a case is described where the detection elements 131 and 132 are arranged such that when pole of the magnet 4b facing the first detection element 131 changes to S-pole from N-pole, pole of the magnet 4b facing the second detection element 132 simultaneously changes to S-pole from N-pole. In this case, it is assumed that dimensions are the same between N-pole and S-pole in the circumferential direction which are alternately arranged in the circumferential direction of which the center is the rotational axis of the rotor 4. At this time, when the detection element 131 outputs a high level signal, the detection element 132 outputs a high level signal. On the other hand, when the detection element 131 outputs a low level signal, the detection element 132 outputs a low level signal. In other words, in the above-described case, the output signals simultaneously outputted from two systems completely match when overlapping the waveform thereof. In other words, the above-described arrangement does not produce a phase difference between output signals. In the following description, for the sake of convenience, an arrangement in which no phase difference is produced between signals outputted by respective detection elements is referred to as “no phase difference arrangement”.

In the case where an arrangement is used such that no phase difference is produced between the detection elements 131 and 132, since the number of pulses of the synthesized signal does not increase even when synthesizing these signals, the resolution cannot be improved in an extremely low speed travelling. Hence, the detection elements 131 and 132 are arranged to simultaneously output signals having mutually different phases at peaks of respective signals such that the number of pulses increases in the synthesized signal when synthesizing the respective signals as needed.

That is, the detection elements 131 and 132 are arranged to avoid producing no phase difference. Specifically, as shown in FIG. 6, one period 1λ is defined as a period from a transition timing of N-pole to S-pole to a re-transition timing of N-pole to S-pole, or an opposite period thereof. At this moment, as shown in FIG. 6, the detection elements 131 and 132 are arranged such that the signal outputted by the second detection element 132 is shifted towards the right side in FIG. 6 (i.e., the advancing direction) by ¼λ with respect to the signal outputted by the first detection element 131. With this arrangement of the detection elements 131 and 132, the output signals of two systems have a phase difference of ¼λ. In the following description, for the sake of convenience, such an arrangement of the detection elements 131 and 132 producing the above-described state is referred to as “arrangement with ¼λ phase difference”.

As shown in FIG. 6, the detection elements 131 and 132 arranged with ¼λ phase difference outputs a signal such that during a period where one signal is in low state, the other signal is in high state and this phase relationship alternately continues. When synthesizing these output signals of two systems by the external ECU, waveform can be obtained where the number of high pulses is doubled compared to the pulses before synthesizing.

Thus, in the case where synthesized signal is used as needed, a plurality of detection elements 13 having phase difference in their output signals are configured so as to increase the number of pules in the synthesized signal. Hence, a rotation detection apparatus is obtained improving the detection resolution even in an extreme low travelling state of the vehicle where the resolution is degraded with single detection element 13.

In the above-described embodiment, an example has been described in which a ¼λ phase difference is used as an ideal phase difference in the output signals outputted by the detection elements 131 and 132. However, the phase difference is not strictly ¼λ but other phase difference can be used as long as the number of pulses increases in the synthesized signal. For example, the phase difference may be within a range of ±20% to 30% with respect to ¼λ of phase difference.

With reference to FIG. 7, specific arrangement of the detection elements 131 and 132 will be described.

For example, as shown in FIG. 7, 0 degree is defined as a position at which the detection portion 131a of the detection element 131 is disposed on the circumference having the center as a rotational axis X, and a round of the circumference is defined as 360 degrees. Further, the dimensions of the N-pole magnet and the S-pole magnet of the multipolar magnet are the same in the circumferential direction having the center thereof as the rotational axis X. Each of the number of N-poles and the number of S-poles of the multipolar magnet 4b is defined as n.

In this case, when assuming that the magnets are arranged corresponding to the ¼λ phase difference, the second detection element 132 is disposed in a position that satisfies the following equation (1).

(180/n·m+90/n) equation (1)

where m satisfies 0≤m<2n, n is a natural number of 1 or larger In the equation (1), 180/n refers to a dimension of one N-pole magnet or one S-pole magnet in the circumferential direction (i.e., unit dimension). For example, 90/n refers to half of the unit dimension. In other words, the position of the second detection element 132 that satisfies the equation (1) refers to that the detection portion 132a of the second detection element 132 is located on the center portion of the N-pole magnet or the S-pole magnet in the circumferential direction, when the detection portion 131a of the first detection element 131 is located on a boundary portion between the N-pole magnet and the S-pole magnet.

As shown FIG. 7, according to the present embodiment, the second detection element 132 is disposed in an opposite side across the rotational axis X of the rotor 4 with respect to the first detection element 131, to have ¼λ phase difference with respect to the output signal of the first detection element 131. Specifically, the first detection element 131 is located at 0 degree position and the second detection element 132 is located at the furthest position such as the (180+90/n) or (180−90/n) degree position.

The detection elements 131 and 132 may be disposed such that respective output signal are shifted by a ¼λ phase difference, and each of the detection elements 131 and 132 is not necessarily disposed along the radial direction of the circle of which the center thereof is the rotation axis X as shown in FIG. 7. In other words, the first detection element 131 and the second detection element 132 may be disposed in parallel. In this case, for example, the first detection element 131 may be disposed at a position corresponding to (0−45/n) degree and the second detection element 132 may be disposed at a position corresponding to (180−45/n) degree. Thus, the detection elements 131 and 132 may be arranged in various ways as long as the output signals have some phase difference.

The lead portions 14 and the terminals 15 electrically connected to each of the detection elements 131 and 132 are extended towards the connector portion disposed around the center of the bottom surface portion 11b of the cover 11 when viewed from the bottom surface normal direction and consolidated around the center. Thus, the lead portions 14 and the terminals 14 arranged in a space having a narrow substantial cylindrical shape are unlikely to interfere to each other. Therefore, the rotation detection apparatus has a structure capable of simplifying wiring layout in the apparatus.

According to the present embodiment, a configuration is employed in which a plurality of detection elements that output signals having mutually different phases at the waveform peak thereof so as to increase the number of pulses by synthesizing the respective output signals, thereby improving the detection resolution, even in a case where the rotor 4 rotates at an extremely low rotation rate. Thus, according to the rotation detection apparatus of the present embodiment, the detection resolution during extremely low speed travelling can be improved and an increase of processing load of external ECU in high speed rotation speed can be avoided, without increasing the number of pulses of respective output signals outputted by a plurality of detection elements 13.

Since the rotation detection apparatus according to the present disclosure is able to detect extremely low speed rotation more accurately than a conventional apparatus, the rotation detection apparatus according to the present disclosure is able to improve accuracy of braking control during a parking operation or parking support using the same, or to detect sliding of a vehicle when stopping on a slope. Further, according to the configuration having a plurality of detection elements 13, even if one of the detection elements 13 has failed, the rest of the detection element 13 can be used to maintain the operation. This is favorable from a fail-safe point of view.

### Other Embodiment

The above-described rotation detection apparatus according to the first embodiment is one example of the present disclosure and not limited to the first embodiment. The rotation detection apparatus of the present disclosure can be appropriately modified in various ways within the scope of the claims.

(1) For example, in the above-described first embodiment, a configuration is exemplified in which two detection elements 13 are arranged. However, three or more detection elements 13 may be arranged. When three detection elements 13 are arranged, the phase difference between output signals outputted by respective detection elements 13 may be set to be 60°, and the number of pulses in the synthesized signal may be set to be three times the number of pulses corresponding to each detection element 13. Even in this case, the phase difference of the signals is set to be 60° ideally, but it is not necessarily set to be strictly 60° when the number of pulses increases in the synthesized signal.

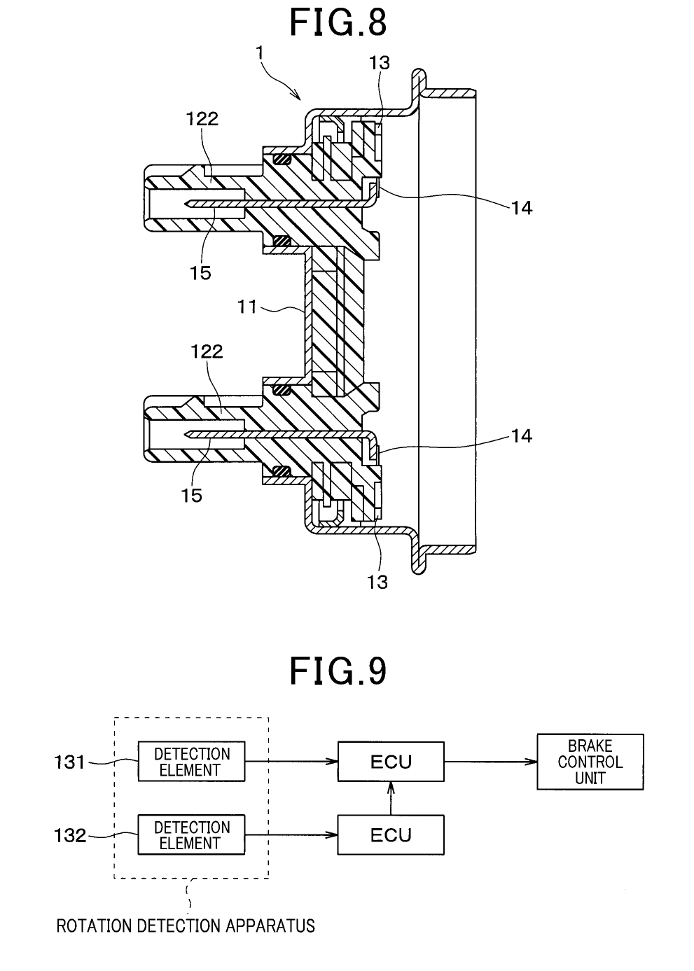

(2) In the above-described first embodiment, a configuration is exemplified in which an opening of the cover 11 and a connector portion 122 of the resin formation portion 12 in the sensor body 1 are provided around the center of the cover 11 when viewed from the bottom surface normal direction. However, as shown in FIG. 8, a plurality of openings in the cover 11 and a plurality of connector portions 122 may be provided as long as each of the signals from the plurality of detection elements 13 is transmitted to the external ECU or the like.

Since the output signal outputted by the detection element 13 is required to be transmitted to the external ECU or the like, instead of the terminal 15, a wire may be electrically connected the lead portion 14 and may be extended from the connector portion 122 towards outside.

(3) According to the above-described first embodiment, a configuration is exemplified in which two detection elements 13 output signals to a single external ECU. However, as shown in FIG. 9, each of the two detection elements 131 and 132 may output a signal to respective ECUs. In this case, the signals of the detection elements 131 and 132 transmitted to the respective ECUs may be shared by one ECU and transmitted to a brake control unit of a vehicle after synthesizing the signals.

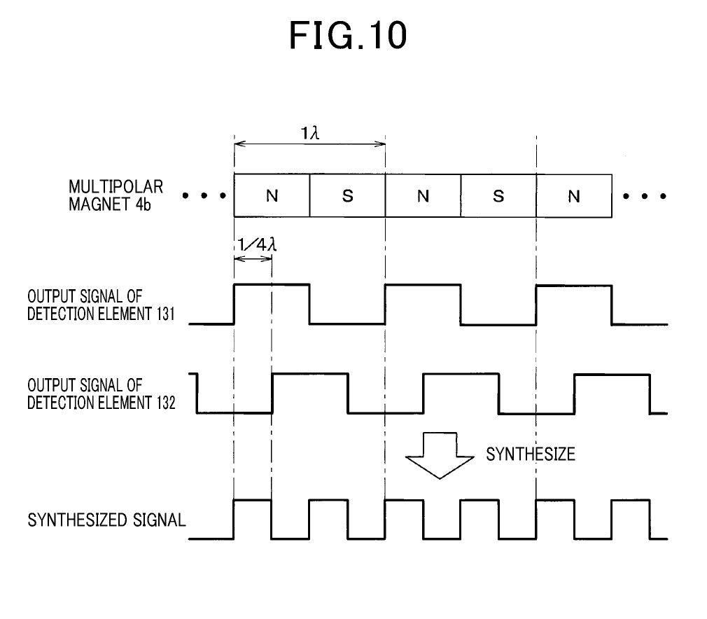

(4) According to the above-described first embodiment, as exemplified in FIG. 4, the output signal of the first detection element 131 rises at a boundary portion between poles, falls before arriving at a boundary portion between the next poles and rises at the boundary portion between the next poles, and these operations are repeated. However, the output signals of the detection elements 131 and 132 may have waveforms having phase difference therebetween and may be synthesized, thereby increasing the number of pulses. In other words, for example, as shown in FIG. 10, the output signal of the first detection element 131 may be a repeated waveform where the signal rises at a boundary portion between poles and falls at a boundary portion between next poles, having ¼λ phase difference relative to the output signal of the second detection element 132. Also, in this case, when synthesizing respective output signals of the detection elements 131 and 132, a synthesized signal having doubled number of pules is obtained as shown in FIG. 10 so that the resolution can be improved. Thus, the output signals of the detection elements 131 and 132 can be appropriately modified in their waveforms.

In FIG. 10, an arrangement of the multipolar magnet 4b corresponding to the output signal of the first detection element 131 is shown, while an arrangement of multipolar magnets 4b corresponding to the output signal of the second detection element 132 is omitted in order to easily understand the phase difference between the output signals of the detection elements 131 and 132. In FIG. 10, an auxiliary line is shown with a chain line in order to easily understand the phase difference between the output signals of the detection elements 131 and 132.

(5) According to the above-described first embodiment, a configuration is exemplified in which the sensor body 1 is attached to the hub unit 5 having a rotor 4 as a magnetizing rotor. However, the rotor 4 is not limited to a magnetizing rotor, but may be configured as any type of rotor as long as the detection unit 13 outputs a signal responding to a change in the magnetic flux caused by the rotation of the rotor 4 in the hub unit 5.

What is claimed is:

1. A rotation detection apparatus comprising:
a plurality of detection elements each outputting a signal responding to a change in magnetic flux caused by rotation of a rotor; and
a sensor body including the plurality of detection elements, wherein:
the plurality of detection elements output signals having mutually different phases with respect to peaks of waveforms corresponding to respective output signals.

2. The rotation detection apparatus according to claim 1, wherein
the rotor serves as a magnetizing rotor provided with a multipolar magnet formed in a circular shape in which magnets are magnetized with N poles and S poles alternating in a circumferential direction of which the center is defined as a rotational axis of the rotor;
two detection elements are provided each having a detection portion;
when one detection portion of the detection element is located at a boundary portion between the N pole and the S pole, the other detection portion of the detection element is located at a portion different from the boundary portion, when viewed in a rotational axis direction.

3. The rotation detection apparatus according to claim 2, wherein
when each number of N poles and S poles is defined as n (n≥1), a position of the one detection portion on a circumference of a circle of which the center is the rotational axis is defined as 0 degree, and a round of the circumference is defined as 360 degrees, the other detection portion is disposed at a position of 180/n·m+90/n degrees, where 0≤m<2n.

4. The rotation detection apparatus according to claim 3, wherein the other detection portion of the detection element is disposed at a position of 180+90/n degrees or a position of 180−90/n degrees.

5. The rotation detection apparatus according to claim 1, wherein
the sensor body is attached to a hub unit provided with the rotor, a hub shaft, and a hub unit bearing including a hub inner wheel and a hub outer wheel having different radiuses, and a rolling body;
the hub outer wheel is disposed such that an inner wall of the hub outer wheel surrounds an outer wall of the hub inner wheel via the rolling body;
the hub unit bearing is configured such that a part of the hub shaft is inserted inside the hub inner wheel to be integrated with the hub shaft;
the rotor is fixed to the hub inner wheel; and
the sensor body is fixed to the hub unit bearing so as to cover an end face to which the rotor is fixed in the hub bearing unit.
